(19) United States
(12) Patent Application Publication
(10) Pub. No.: US 2009/0183676 A1
(43) Pub. Date: Jul. 23, 2009

(54) COATING SOLUTION SUPPLY APPARATUS

(75) Inventors: Hiroyuki FUJII, Koshi-shi (JP); Kazuhiro Nishijima, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/349,722

(22) Filed: Jan. 7, 2009

(30) Foreign Application Priority Data
Jan. 21, 2008 (JP) 2008-010242

(51) Int. Cl. B05C 5/02

(52) U.S. Cl. 118/663; 118/300

(57) ABSTRACT

A coating solution supply apparatus of the present invention has a closed-type coating solution supply source which stores the coating solution therein; a supply pipe for supplying the coating solution from the coating solution supply source to the coating nozzle; and a pump which is provided along the supply pipe and pressure-feeds the coating solution to the coating nozzle, wherein an inside of the coating solution supply source is pressurized to a predetermined pressure by supply of an inert gas to prevent the inside of the coating solution supply source from being brought to a negative pressure even when the pump is operated to pressure-feed the coating solution to the coating nozzle.

### BACKGROUND OF THE INVENTION

1. Field of the Invention

The present invention relates to a coating solution supply apparatus which supplies a coating solution to a coating nozzle for discharging the coating solution to a substrate.

2. Description of the Related Art

In a process of forming a multilayer wiring structure of, for example, a semiconductor integrated circuit and the like, treatment of forming an insulating film between metal wires on a semiconductor wafer (hereinafter, referred to as a “wafer”) is performed. For the treatment of forming the insulating film, a coating treatment method is widely used in which, for example, a coating solution of an insulating film material in the liquid form is applied from a coating nozzle onto the wafer, spread over the front surface of the wafer by rotating the wafer, and then hardened. With this coating treatment method, for example, an SOD (Spin On Dielectric) film or an SOG (Spin On Glass) film is formed as the insulating film.

It is necessary to stably perform discharge of the coating solution from the coating nozzle in order to uniformly form such an insulating film with a desired film thickness. To this end, it is necessary to stably supply the coating solution to the coating nozzle.

Conventionally, a coating solution supply apparatus having a coating solution supply source which stores the coating solution and a pump which pressure-feeds the coating solution from the coating solution supply source to the coating nozzle has been proposed as a coating solution supply apparatus which supplies the coating solution to the coating nozzle (Japanese Patent Application Laid-open No. 2006-26546). With the prior art, ambient air flows into the coating solution supply source through an opening portion or a valve of the coating solution supply source in accordance with the amount of the coating solution which has been pressure-fed by operation of a pump.

### SUMMARY OF THE INVENTION

However, the coating solution of the insulating film material such as the SOD film is highly reactive and therefore tends to react with oxygen, water and so on to deteriorate. Accordingly, in the conventional coating solution supply apparatus in which air flows into the coating solution supply source, the coating solution could not be used for a long period of time because the coating solution tends to react with oxygen, water and so on in the air to deteriorate.

The present invention has been developed in consideration of the above point, and an object of the present invention is to use a coating solution in a coating solution supply apparatus for a long period of time while stably supplying the coating solution to a coating nozzle, even if a highly reactive coating solution is used when the coating solution is supplied to the coating nozzle using the coating solution supply apparatus.

To attain the above object, the present invention is a coating solution supply apparatus which supplies a coating solution to a coating nozzle for discharging the coating solution to a substrate, the apparatus having a closed-type coating solution supply source which stores the coating solution therein; a supply pipe for supplying the coating solution from the coating solution supply source to the coating nozzle; and a pump which is provided along the supply pipe and pressure-feeds the coating solution to the coating nozzle. An inside of the coating solution supply source is pressurized to a predetermined pressure by supply of an inert gas from an inert gas supply source to prevent the inside of the coating solution supply source from being brought to a negative pressure even when the pump is operated to pressure-feed the coating solution to the coating nozzle.

According to the present invention, the coating solution can be pressure-fed at a predetermined flow rate and the coating solution can be stably supplied to the coating nozzle, while employing the closed-type coating solution supply source. Further, accurate supply is performed because of the pressure feeding by the pump. In addition, the inert gas is supplied into the closed-type coating solution supply source, so that even when a highly reactive coating solution of an insulating film material such as an SOD film, an SOG film or the like is used as the coating solution, no air can flow into the coating solution supply source, unlike the prior art, thus preventing deterioration of the coating solution due to reaction with oxygen or water. Accordingly, the coating solution stored in the coating solution supply source is usable for a long period of time even when a highly reactive coating solution is used.

### BRIEF DESCRIPTION OF THE DRAWINGS

FIG. 1 is a longitudinal sectional view showing the outline of a configuration of a coating treatment apparatus;

FIG. 2 is a transverse sectional view showing the outline of the configuration of the coating treatment apparatus;

FIG. 3 is an explanatory view showing the outline of a configuration of a coating solution supply apparatus according to this embodiment; and

FIG. 4 is a longitudinal sectional view showing the outline of a configuration of a deaeration mechanism.

### DETAILED DESCRIPTION OF THE INVENTION

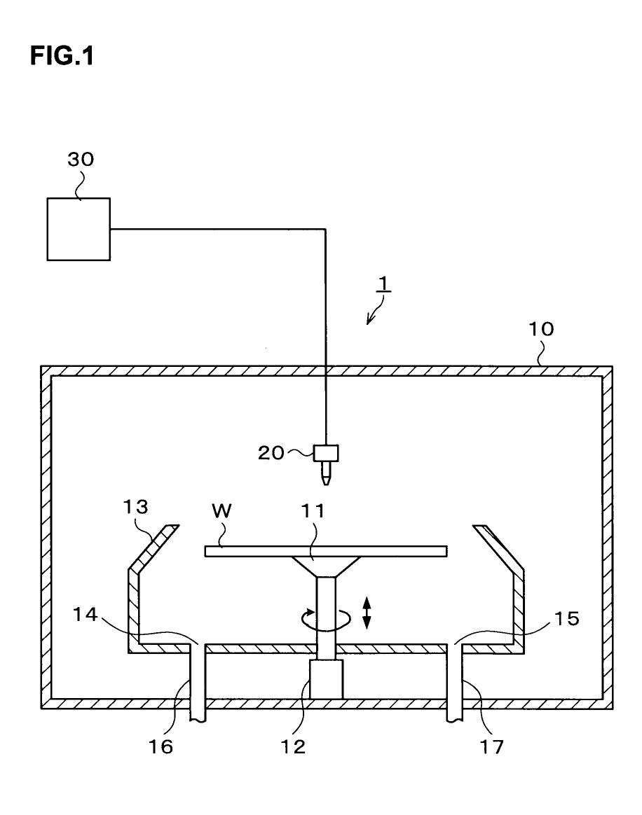

Hereinafter, a preferred embodiment of the present invention will be described. FIG. 1 is a longitudinal sectional view showing the outline of a configuration of a coating treatment apparatus 1 in which a coating solution supply apparatus according to this embodiment is applied. Note that a coating solution for an SOD film as a coating solution, for example, SPINFIL (registered trademark of AZ Electronic Materials Co.,Ltd.) is used in this embodiment. SPINFIL contains, for example, perhydrosilazane (solute) and dibutyl ether (solvent).

The coating treatment apparatus 1 has a treatment container 10 capable of closing its inside as shown in FIG. 1. Inside the treatment container 10, a spin chuck 11 is provided which horizontally holds the wafer W by vacuum suction on the upper surface thereof. The spin chuck 11 can rotate about the vertical by means of a drive mechanism 12 which includes a motor and so on. Further, the drive mechanism 12 is provided with a raising and lowering drive source (not shown) such as a cylinder or the like so that the spin chuck 11 can rise and lower.

Around the spin chuck 11, a cup body 13 is provided which receives and collects liquid splashing or dropping from the wafer W. An opening portion larger than the wafer W and the spin chuck 11 is formed in the upper surface of the cup body 13 to allow the spin chuck 11 holding the wafer W thereon to rise and lower. A drain port 14 for draining the collected coating solution and an exhaust port 15 for exhausting the atmosphere in the cup body 13 are formed at the bottom of the cup body 13. The drain port 14 and the exhaust port 15 are connected to a drain pipe 16 and an exhaust pipe 17 respectively, and an exhaust pump (not shown) for vacuuming the atmosphere inside the container 10 is connected to the exhaust pipe 17.

Above the spin chuck 11, a coating nozzle 20 is disposed for applying the coating solution onto the central portion of the front surface of the wafer W. The coating nozzle 20 is connected to a coating solution supply apparatus 30 which supplies the coating solution.

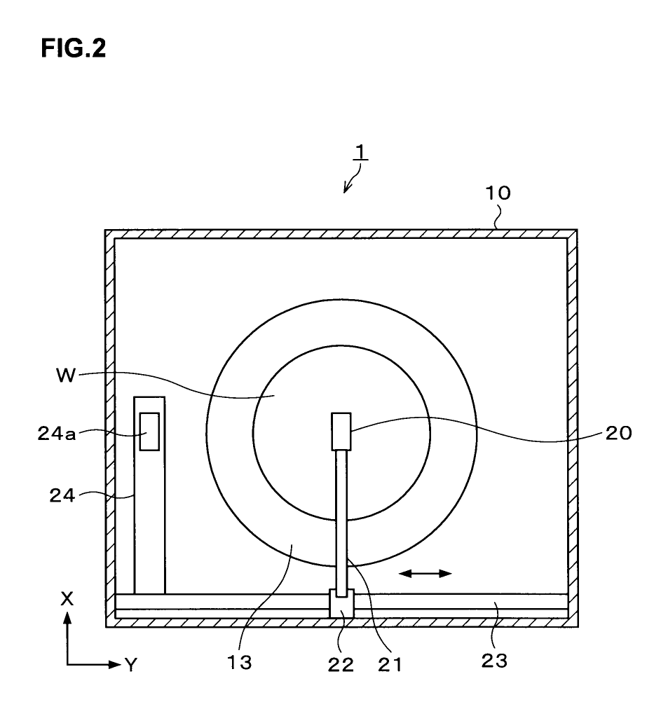

The coating nozzle 20 is connected to a moving mechanism 22 via an arm 21 as shown in FIG. 2. The arm 21 can move from a waiting area 24 provided outside the cup body 13 on one end side (the left side in FIG. 2) toward the other end side along a guide rail 23 provided along the length direction (a Y-direction) of the treatment container 10 by means of the moving mechanism 22, and can move in the vertical direction. The waiting area 24 is configured to be able to house the coating nozzle 20 therein and has a cleaning section 24a capable of cleaning the tip portion of the coating nozzle 20.

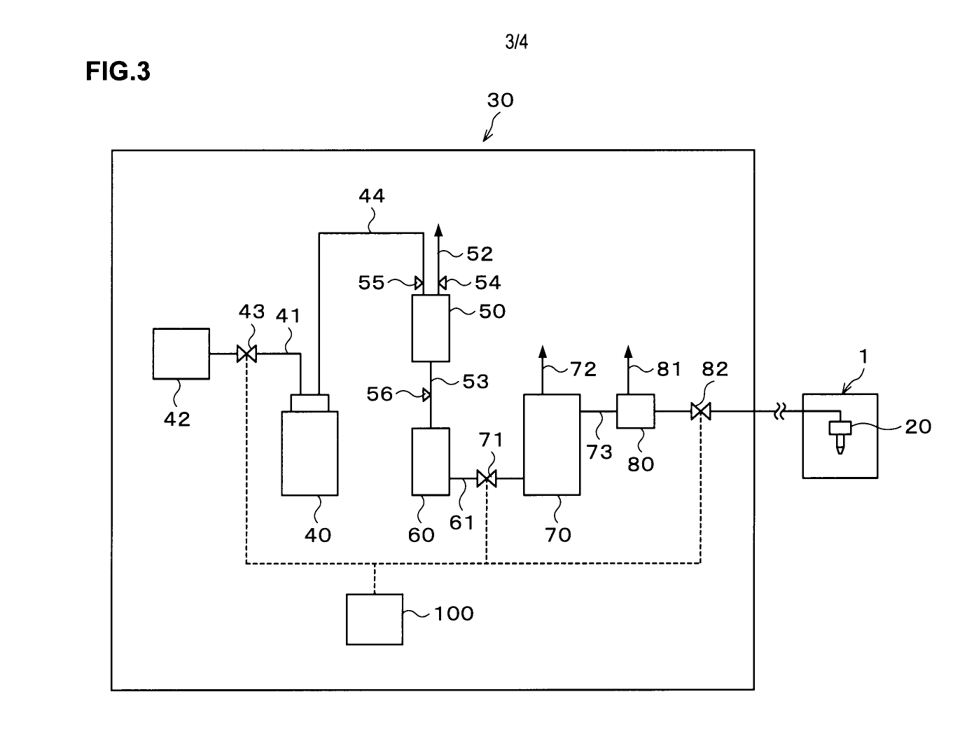

Next, a configuration of the coating solution supply apparatus 30 which supplies the coating solution to the coating nozzle 20 in the coating treatment apparatus 1 will be described. FIG. 3 is an explanatory view showing the outline of the configuration of the coating solution supply apparatus 30.

The coating solution supply apparatus 30 has a closed-type coating solution supply source 40 which stores the coating solution as shown in FIG. 3. To an upper portion of the coating solution supply source 40, a nitrogen gas supply source 42 is connected which supplies a nitrogen gas as an inert gas into the coating solution supply source 40. The inert gas is not limited to the nitrogen gas. The gas supply pipe 41 is provided with a valve 43. The opening degree of the valve 43 is controlled by a later-described control unit 100 so that the opening degree of the valve 43 is controlled to control the supply amount of the nitrogen gas to be supplied to the coating solution supply source 40.

The control unit 100 controls the supply amount of the nitrogen gas such that the pressure in the coating solution supply source 40 during supply of the coating solution is maintained at a predetermined pressure, for example, 5 kPa. Note that the predetermined pressure is decided to be a pressure having no influence on the pressure feeding of the coating solution by a later-described pump 70 in consideration of the position (level) of the coating solution supply source 40 and the loss of pressure from the coating solution supply source 40 to the pump 70. Further, the pressure is decided such that even if the nitrogen gas is dissolved in the coating solution, a pressure to prevent the dissolved nitrogen gas from bubbling during supply of the coating solution to the pump 70, that is, a positive pressure is applied on the coating solution. For example, if the pressure applied on the coating solution is −3 kPa when the coating solution at normal pressures is supplied to the pump 70, the predetermined pressure in the coating solution supply source 40 is determined to be 5 kPa in consideration of a margin of 1 kPa. Further, the control unit 100 can control the supply amount of the nitrogen gas so that the pressure in the coating solution supply source 40 becomes a pressure higher than the predetermined pressure, for example, 50 kPa, at the start of supplying the coating solution, for example, when the coating solution supply source 40 is replaced with another and the operation of the coating solution supply apparatus 30 is started again and so on. Application of such a higher pressure makes it possible to pressure-feed the coating solution from the coating solution supply source 40 to the coating nozzle 20 without operating the pump 70.

At the upper portion of the coating solution supply source 40, a pipe 44 is provided which permits the coating solution in the coating solution supply source 40 to flow out. The upper potion of the coating solution supply source 40 is preferably located at a position as high as possible in order to help the application of pressure in the pipe 44. Then, the nitrogen gas is supplied into the coating solution supply source 40 to apply a pressure in the coating solution supply source 40, whereby the coating solution is pressure-fed from the coating solution supply source 40 to the pipe 44.

A liquid end tank 50 which temporarily stores the coating solution is connected to the downstream side of the coating solution supply source 40 via the pipe 44.

The liquid end tank 50 is a tank, for example, having an outer shape in a cylindrical form, and an auxiliary pipe 52 for exhausting a gas in the liquid end tank 50 is provided at its upper portion and a pipe 53 for permitting the coating solution in the liquid end tank 50 to flow out is connected to its lower portion. Sensors 54 and 55 are provided along the auxiliary pipe 52 on the side of the outlet of the liquid end tank 50 and along the pipe 44 on the side of the inlet of the liquid end tank 50, respectively. The sensors 54 and 55 can detect bubbles of the nitrogen gas and so on in the liquid end tank 50 when the coating solution in the coating solution supply source 40 runs out. When the sensors 54 and 55 detect bubbles, the bubbles of the nitrogen gas and so on are exhausted through the auxiliary pipe 52. Further, the coating treatment is finished after the treatment for a lot which is presently being treated, for example, for 25 wafers W. The liquid end tank 50 also serves as a buffer tank, so that it can supply the coating solution stored in the liquid end tank 50 to the coating nozzle 20 even when the coating solution to be supplied from the coating solution supply source 40 runs out as described above. Note that the liquid end tank 50 is preferably located at a position as high as possible so as to capture the bubbles with ease.

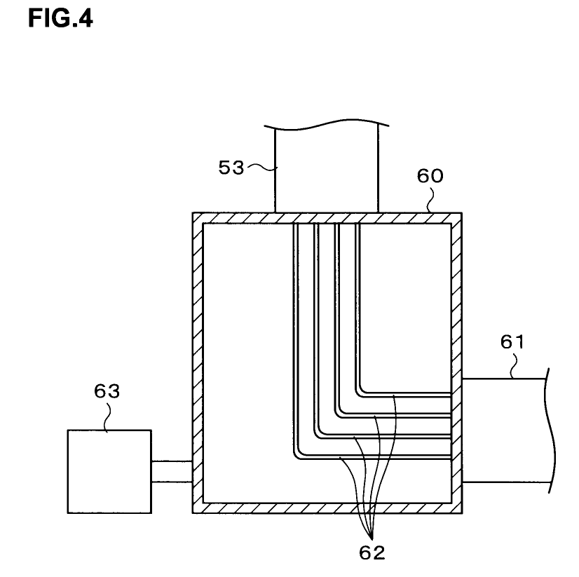

On the downstream side of the liquid end tank 50, a deaeration mechanism 60 which removes the gas dissolved in the coating solution, such as the nitrogen gas, is connected via the pipe 53. The deaeration mechanism 60 is provided with a pipe 61 which permits the coating solution in the deaeration mechanism 60 to flow out. In the deaeration mechanism 60, a plurality of tubes 62 which connect the pipe 53 on the inlet side of the deaeration mechanism 60 and the pipe 61 on the outlet side are provided as shown in FIG. 4. For the tubes 62, a material which is excellent in chemical resistance and has a property to permit no liquid but only gas to pass therethrough, such as PTFE, PFA, FEP or the like. Further, the deaeration mechanism 60 is provided with a suction device 63 which sucks by vacuum the inside of the aeration mechanism 60. Then, the inside of the deaeration mechanism 60 is sucked by vacuum by means of the suction device 63, whereby the gas such as the nitrogen gas or the like in the coating solution flowing through the tubes 62 can be sucked. Further, the pipe 53 on the downstream side of the liquid end tank 50 is provided with a sensor 56 which can detect bubbles. When the sensor 56 detects bubbles, the discharge treatment of the coating solution is forcibly ended, and the bubbles are ejected via the deaeration mechanism 60 or a later-described exhaust pipe 72 of the pump 70.

To the downstream side of the deaeration mechanism 60, the pump 70 which pressure-feeds the coating solution to the coating nozzle 20 via the pipe 61 is connected as shown in FIG. 3. The pipe 61 is provided with a valve 71. The valve 71 is, for example, an air-operation valve, which starts or stops the supply of the coating solution by the pump 70 from the deaeration mechanism 60 by control of the control unit 100. At the upper portion of the pump 70, an exhaust pipe 72 is provided which exhausts air in the pump 70. The pump 70 is provided with a pipe 73 which permits the coating solution in the pump 70 to flow out. Note that for the pump 70, for example, a tubephragm-type pump is used, which can stably pressure-feed the coating solution even if the pipe system in the coating solution supply apparatus 30 is pressurized to a predetermined pressure (for example. 10 kPa or less) by the nitrogen gas as in this embodiment.

The pump 70 is connected to the coating nozzle 20 of the coating treatment apparatus 1 via the pipe 73. The pipe 73 is provided with a filter 80 which removes impurities in the coating solution. At the upper portion of the filter 80, a pipe 81 is provided which ejects the removed impurities to the outside. Note that the filter 80 is preferably located at a position as high as possible so as to easily capture bubbles.

On the downstream side of the filter 80 along the pipe 73, a valve 82 is provided. The valve 82 is, for example, an air-operation valve which starts or stops the supply of the coating solution from the pump 70 to the coating nozzle 20 by control of the control unit 100. Note that the pipes 44, 53, 61 and 73 constitute a supply pipe of the coating solution, and the mechanisms in the coating solution supply apparatus 30 are preferably arranged such that the supply pipe is as short as possible.

The coating solution supply apparatus 30 according to this embodiment is configured as described above, and the operation of the coating solution supply apparatus 30 when supplying the coating solution will be described next.

When starting the supply of the coating solution by the coating solution supply apparatus 30, for example, when replacing the coating solution supply source 40 with another and starting again the operation of the coating solution supply apparatus 30, first of all, the opening degree of the valve 43 is controlled by the control unit 100 and the nitrogen gas is then supplied into the coating solution supply source 40. Then, the inside of the coating solution supply source 40 is pressurized to a pressure higher than the predetermined pressure during normal supply, for example, 50 kPa. Thereafter, the valves 71 and 82 are opened to pressure-feed the coating solution from the inside of the coating solution supply source 40 to the coating nozzle 20 only by the pressurization of the nitrogen gas without operating the pump 70. This operation allows the gas stored in the pipes 44, 53, 61, and 73, the liquid end tank 50, the deaeration mechanism 60, the pump 70, the filter 80 and so on during the stop of operation of the coating solution supply apparatus 30 to be removed by the coating solution pressure-fed at the high pressure. Further, when the coating solution flows through the filter 80 at the start of operation of the coating solution supply apparatus 30, the coating solution cannot flow into the filter 80 sometimes if the surface tension of the coating solution is higher than the solid surface tension of the filter 80 because the filter 80 itself does not always have excellent wettabilty (high solid surface tension). Consequently, the gas in the filter 80 forms into bubbles which are mixed into the coating solution. Even such a case, the filter 80 can be made accustomed to the coating solution by pressure-feeding the coating solution at a high pressure as described above so as to allow the coating solution to pass therethrough without producing bubbles at the filter 80. Note that no wafer W is housed in the coating treatment apparatus 1 during this operation.

After completion of the above-described preparation operation, the control unit 100 reduces the supply amount of the nitrogen gas supplied into the coating solution supply source 40 to maintain the inside of the coating solution supply source 40 at the predetermined pressure, for example, 5 kPa. At this pressure, the coating solution is pressure-fed from the coating solution supply source 40 to the pump 70 via the liquid end tank 50 and the deaeration mechanism 60. In this event, the coating solution is temporarily stored in the liquid end tank 50, and the suction device 63 operates in the deaeration mechanism 60 to suck the gas in the coating solution, such as the nitrogen gas and the like. Note that when the coating solution is pressure-fed, the wafer W is transferred into the coating treatment apparatus 1.

The coating solution supplied into the pump 70 is then fed from the pump 70 via the filter 80 to the coating nozzle 20 of the coating treatment apparatus 1 at a predetermined flow rate and with a predetermined pressure. In this event, the impurities in the coating solution are removed by the filter 80.

Once the coating solution is supplied to the coating nozzle 20, the wafer W sucked onto the spin chuck 11 is rotated by the drive mechanism 12 in the coating treatment apparatus 1, and the coating solution is dripped to the central portion of the wafer W from the coating nozzle 20. The coating solution applied to the wafer W spreads over the front surface of the wafer W by the centrifugal force generated by the rotation of the wafer W to form a coating film on the front surface layer of the wafer W.

After completion of the formation of the coating film on the wafer W, the application of the coating solution from the coating nozzle 20 is stopped. More specifically, the operation of the pump 70 of the coating solution supply apparatus 30 is stopped and the valves 71 and 82 are closed by the control unit 100. Note that when the valve 71 is closed, the pressure in the pipes 44, 53 and 61 instantaneously lowers, but the inside of the pipes 44, 53 and 61 is never brought to a negative pressure because the coating solution supply source 40 is maintained at the predetermined pressure.

When the next wafer W is sucked onto the spin chuck 11 in the coating treatment apparatus 1 and rotated by the drive mechanism 12, the operation of the pump 70 is started again and the valves 71 and 82 are opened by the control unit 100 to supply the coating solution to the coating nozzle 20.

As described above, the supply of the coating solution from the coating solution supply apparatus 30 to the coating nozzle 20 is continuously performed. Note that even when the coating solution in the coating solution supply source 40 runs out, the coating solution stored in the liquid end tank 50 can be supplied to the coating nozzle 20.

According to the above embodiment, since the nitrogen gas is supplied into the closed-type coating solution supply source 40 storing the coating solution to pressurize the inside of the coating solution supply source 40 to a predetermined pressure, no air can flow into the coating solution supply source, unlike the prior art, thus preventing deterioration of the coating solution due to reaction with oxygen or water. Accordingly, the coating solution stored in the coating solution supply source 40 is usable for a long period of time. This makes it possible to decrease the exchange frequency of the coating solution source 40 itself and improve the operation rate of the coating solution supply apparatus 30. Since the coating solution which will deteriorate and go to waste can be reduced, the consumption of the coating solution can also be reduced.

The inside of the coating solution supply source 40 is pressurized to prevent the inside of the pipes 44, 53 and 61 from being brought to a negative pressure, so that even if gas such as the nitrogen gas or the like dissolves in the coating solution, bubbling of the gas can be suppressed.

Since pressurization to the predetermined pressure is performed to prevent the inside of the coating solution supply source 40 and the pipes 44, 53 and 61 from being brought to negative pressure and the pump 70 can pressure-feed the coating solution at the predetermined flow rate with a high accuracy, the coating solution at the predetermined flow rate can be supplied from the coating solution supply source 40 to the coating nozzle 20.

The deaeration mechanism 60 is provided between the coating solution supply source 40 and the pump 70, so that if gas such as the nitrogen gas or the like dissolves in the coating solution, the gas can be removed from the coating solution. This avoids production of bubble of the nitrogen gas or the like in the coating solution, for example, even when the coating solution is discharged from the coating nozzle 20 under the atmospheric pressure.

The liquid end tank 50 is provided between the coating solution supply source 40 and the pump 70, so that even when the coating solution in the coating solution supply source 40 runs out, the coating solution stored in the liquid end tank 50 can be supplied to the coating nozzle 20. Accordingly, the coating solution can be supplied even while the coating solution supply source 40 is being exchanged with another, thereby further improving the operation rate of the coating solution supply apparatus 30. In this case, the nitrogen gas or the like can be exhausted from the auxiliary pipe 52 of the liquid end tank 50 to remove the bubbles of the nitrogen gas or the like in the coating solution.

Since the filter 80 is provided between the pump 70 and the coating nozzle 20, the impurities can be removed from the coating solution immediately before it is discharged from the coating nozzle 20.

A preferred embodiment of the present invention has been described above with reference to the accompanying drawings, but the present invention is not limited to the embodiment. It should be understood that various changes and modifications are readily apparent to those skilled in the art within the spirit as set forth in claims, and those should also naturally be covered by the technical scope of the present invention. The present invention can take, not limited to the embodiment, various forms. For example, while the present invention has been described taking the coating solution to form an SOD film as an example in the above embodiment, the present invention is also applicable to supply of a coating solution other than the coating solution to form an SOD film, such as a resist solution, a coating solution to form an anti-reflection film or the like, or a developing solution. Further, the present invention is also applicable to case where the substrate is other than the wafer, such as an FPD (Flat Panel Display), a mask reticle for a photomask, and the like.

The present invention is useful, for example, for a coating solution supply apparatus which supplies a coating solution to a coating nozzle for discharging the coating solution to a substrate.

What is claimed is:

1. A coating solution supply apparatus which supplies a coating solution to a coating nozzle for discharging the coating solution to a substrate, said apparatus comprising:
a closed-type coating solution supply source which stores the coating solution therein;
a supply pipe for supplying the coating solution from said coating solution supply source to said coating nozzle; and
a pump which is provided along said supply pipe and pressure-feeds the coating solution to said coating nozzle,
wherein an inside of said coating solution supply source is pressurized to a predetermined pressure by supply of an inert gas from an inert gas supply source to prevent the inside of said coating solution supply source from being brought to a negative pressure even when said pump is operated to pressure-feed the coating solution to said coating nozzle.

2. The coating solution supply apparatus as set forth in claim 1,
wherein a deaeration mechanism which removes the inert gas dissolved in the coating solution is provided along said supply pipe between said coating solution supply source and said pump.

3. The coating solution supply apparatus as set forth in claim 2,
wherein a tank which stores the coating solution is provided along said supply pipe between said coating solution supply source and said deaeration mechanism.

4. The coating solution supply apparatus as set forth in claim 1,
wherein a filter which removes impurities in the coating solution is provided along said supply pipe between said pump and said coating nozzle.

5. The coating solution supply apparatus as set forth in claim 1, further comprising:
a control unit which controls a supply amount of the inert gas to be supplied from said inert gas supply source to said coating solution supply source to pressurize the inside of said coating solution supply source to the predetermined pressure.

6. The coating solution supply apparatus as set forth in claim 5,
wherein said control unit controls the supply amount of the inert gas to pressure-feed the coating solution to said coating nozzle only by the pressurization of the inside of said coating solution supply source when said pump is not operated.
